(19) United States
(12) Patent Application Publication
(10) Pub. No.: US 2011/0070815 A1
(43) Pub. Date: Mar. 24, 2011

(54) INDEXING DRIVE SYSTEM

(75) Inventors: WAYNE SPILLNER, Warrenton, VA (US); Lee Clarkson, Amissville, VA (US); Bill Clowater, Gordonsville, VA (US)

(73) Assignee: Ross Industries, Inc., Midland, VA (US)

(21) Appl. No.: 12/887,391

(22) Filed: Sep. 21, 2010

Related U.S. Application Data
(60) Provisional application No. 61/244,764, filed on Sep. 22, 2009.

(51) Int. Cl. A22C 9/00; F16H 55/17; F16H 57/02

(52) U.S. Cl. 452/141; 74/434; 74/436; 74/412 R

(57) ABSTRACT

A driver for a food conditioner that comprises a drive shaft that is configured to be driven by a motor, a continuous-to-intermittent converter that is configured to be coupled to the drive shaft, and a slip clutch that is configured to be coupled to the continuous-to-intermittent converter, wherein the slip clutch is further configured to disengage when a torque applied to the slip clutch exceeds a predetermined threshold.

### CROSS REFERENCE TO PRIOR APPLICATIONS

This application claims priority under 35 U.S.C. §119(e) to U.S. Provisional Patent Application No. 61/244,764, filed Sep. 22, 2009, and titled “Indexing Drive System for Tenderizer,” the disclosure of which is expressly incorporated by reference herein in its entirety.

### FIELD OF THE DISCLOSURE

The present disclosure relates to an apparatus, a system and a method for driving a device for conditioning food products, such as, for example, meat, poultry, and the like, to improve their texture and improve consumer taste preference for the conditioned product when compared with an equivalent non-conditioned sample.

### BACKGROUND OF THE DISCLOSURE

Mechanical blade tenderizers are commonly used by meat processors to cut through sinew and connective tissue when processing various cuts of meat and poultry. The process of cutting through sinew and connective tissue may increase the desirability of the resultant product, since consumers typically regard the product as more tender and delicious. Generally, when a blade-tenderized product is compared to a similar cut that has not been processed, the tenderized product is generally preferred by consumers by a wide margin (at least a 65% preference).

Currently, ratchet linkage assemblies are frequently used to drive mechanical blade tenderizers. These are complex systems with critical timing issues. The systems require the timing to be set or fined tuned with precision and expertise, requiring a high level of mechanical expertise for maintenance or repair. These systems do not typically include overload protection, so if a jam should occur in the tenderizer, one or more components of the tenderizer drive are likely to break, often a rod end or a linkage arm.

The present disclosure provides an apparatus, a system and a method for driving an indexing device that conditions or further processes food products (for example, non-intact meat and poultry products), such as, for example, a mechanical blade tenderizer, a cuber, a tender press, or injector, for conditioning food products, which provide increased reliability and reduced complexity. The disclosure also provides higher stroke rates as the motion is completed more quickly during each cycle of operation of the apparatus.

### SUMMARY OF THE DISCLOSURE

According to an aspect of the present disclosure, a driver is disclosed for a food conditioner. The driver comprises: a drive shaft that is configured to be driven by a motor; a continuous-to-intermittent converter that is configured to be coupled to the drive shaft; and a slip dutch that is configured to be coupled to the continuous-to-intermittent converter, wherein the slip clutch is further configured to disengage when a torque applied to the slip clutch exceeds a predetermined threshold. The continuous-to-intermittent converter may comprise a Geneva drive gear, or a Maltese Cross drive gear. The driver continuous-to-intermittent converter may comprise: a master drive gear coupled to the drive shaft; and a slave drive gear that is intermittently coupled to the master drive gear. The master drive gear may include a cam follower and wherein the slave drive gear includes a slot that is configured to receive the cam follower.

The slip clutch may comprise: an engager portion that is configured to drive a transporter; and a clutch portion that is configured to disengage the engager portion to cause the engager portion to stop rotation while the drive shaft continues to rotate substantially continuously. The engager portion may comprise a sprocket.

The driver may further comprise: a driven shaft coupled to the continuous-to-intermittent converter and the slip clutch, the driven shaft being configured to drive the slip clutch; or a drive unit that is configured to drive a food processor. The drive unit may comprise a lifter. The driver may further comprise a cam unit that is coupled to the drive shaft.

According to a further aspect of the disclosure, a driver is disclosed for a food conditioner, wherein the driver comprises: a drive shaft that is configured to be driven by a motor; a master drive gear that is coupled to the drive shaft; a driven shaft that is configured to be driven by a force that is transferred from the master drive gear; and a slip clutch that is coupled to the driven shaft. The master drive gear may include a cam follower. The slip clutch may be configured to disengage when a torque applied to the slip clutch exceeds a predetermined threshold. The slip clutch may comprise: an engager portion that is configured to drive a transporter; and a clutch portion that is configured to disengage the engager portion to cause the engager portion to stop rotation while the drive shaft continues to rotate substantially continuously.

The driver may further comprise a slave drive gear that is coupled to the driven shaft. The slave drive gear may be configured to intermittently engage the master drive gear while the master drive gear continues to rotate substantially continuously. The master drive gear may comprise a Geneva drive gear or a Maltese Cross drive gear. The slave drive gear may comprise a slot that is configured to receive a portion of the master drive gear.

According to a still further aspect of the disclosure, a driver is disclosed for a food conditioner. The driver comprises: a drive shaft that is configured to be driven by a motor; a Geneva drive gear coupled to the drive shaft, the Geneva drive gear comprising a cam follower; a driven shaft that is configured to drive a transport; a Maltese Cross drive gear coupled to the driven shaft, the Maltese Cross drive gear comprising a slot for receiving and engaging the cam follower; and a slip clutch coupled to the driven shaft, wherein the slip clutch is configured to disengage when a force applied to the slip clutch exceeds a predetermined threshold.

According to a still further aspect of the disclosure, a driver may be provided for a food conditioner that includes a servo motor and a timing indicator. The driver may include a main drive, the servo motor, a slip clutch and the timing indicator. The timing indicator may be affixed to a rotating cam of the main drive to trigger servo shaft indexing.

Additional features, advantages, and embodiments of the disclosure may be set forth or apparent from consideration of the following attached detailed description and drawings. Moreover, it is to be understood that both the foregoing summary of the disclosure and the following attached detailed description are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a food conditioner that is constructed according to the principles of the disclosure;

FIG. 2A shows an example of a food conditioning head that may be included in the food conditioner of FIG. 1, according to the principles of the disclosure;

FIG. 2B shows a perspective, bottom view of the food conditioning head of FIG. 2A;

FIG. 2C shows a detailed view of an area A noted in FIG. 2B;

FIG. 2D shows a perspective view of an example of a blade carrier of the food conditioning head of FIG. 2A;

FIG. 2E shows a perspective view of an example of a guide plate of the food conditioning head of FIG. 2A;

FIG. 3A shows a detailed, partial x-y plane view of a portion of the food conditioner of FIG. 1;

FIG. 3B shows a detailed, partial z-y plane view of a portion of the food conditioner of FIG. 1;

FIG. 4 shows a perspective view of a drive system that may be included in the food conditioner of FIG. 1;

FIG. 5 shows a detailed view of a portion of the drive system of FIG. 4, constructed according to the principles of the disclosure;

FIG. 6 shows an exploded view of the drive system of FIG. 4;

FIG. 7 shows an example of a slip clutch assembly that may be included in the drive system of FIG. 4, according to the principles of the disclosure;

FIG. 8 shows an example of a sprocket (or pulley) assembly that may be included in the food conditioner of FIG. 1, according to the principles of the disclosure;

FIG. 9 shows a representation of an example of a master drive gear and a complementary slave drive gear that may be included in the drive system of FIG. 4, according to principles of the disclosure;

FIG. 10 shows four discrete examples of the rotational motion of a master drive gear and a slave drive gear that may be used in the drive system of FIG. 4, according to principles of the disclosure; and

FIG. 11 shows another example of a master drive gear and a slave drive gear that may be included in the drive system of FIG. 4, according to principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings, and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices, that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

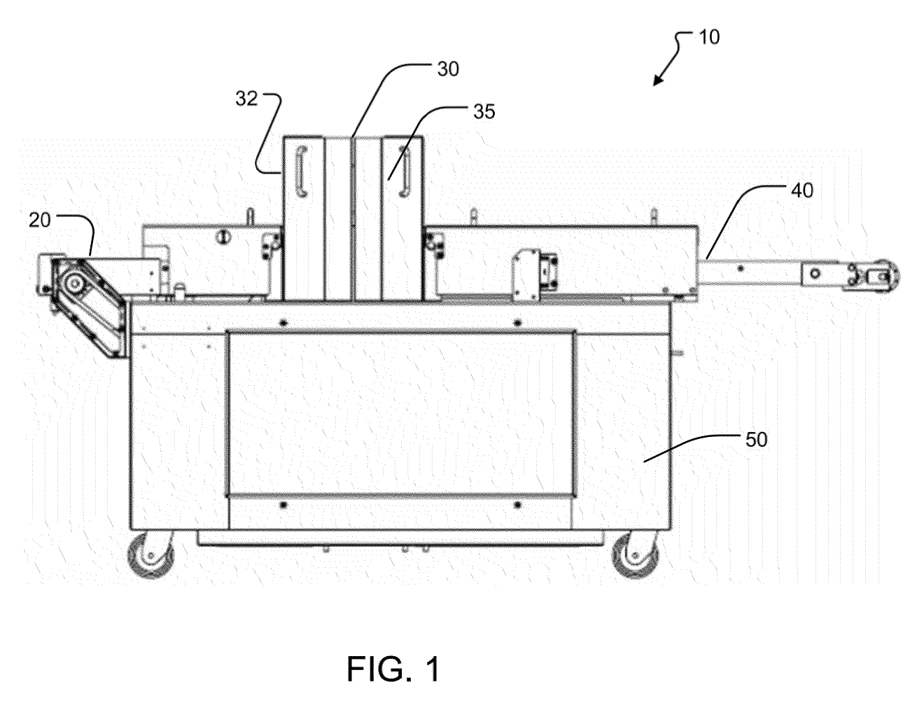

FIG. 1 shows an example of a food conditioner 10, which is constructed according to the principles of the disclosure. The food conditioner 10 may include, for example, a tenderizer, a cuber, a press, or the like, to process a food product. The food conditioner 10 includes an input transport 20, a food processor 30, an output transport 40 and a housing 50. The food processor 30, which may include a tenderizer, a cuber, a press, or the like, may be contained in a housing 32 that may include panel doors 35 for access to a processing chamber (not shown) of the food processor 30. The input transport 20 and output transport 40 may each include, for example, a conveyor belt (not shown). The conveyor belt may include a stainless steel belt, a rubber belt, a plastic belt, or the like, with or without openings. The food processor 30 may include a guard (not shown) on the infeed and discharge sides of the food processor 30. The guard may include a plurality of unidirectional rods (not shown) that form a curtain (not shown) to prevent, for example, from a human hand being inserted in the food processer 30 during operation. The guard may be coupled to an interlock safety switch (not shown), which may be configured to prevent operation of the food conditioner 10 when any of the guards are dislodged or removed.

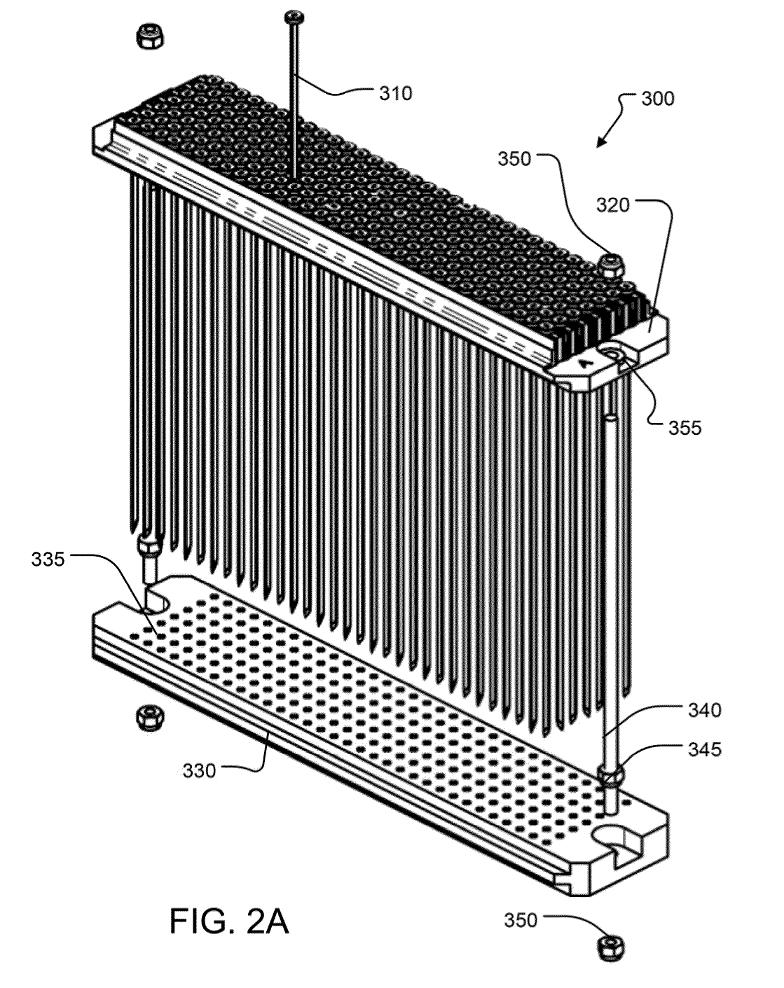

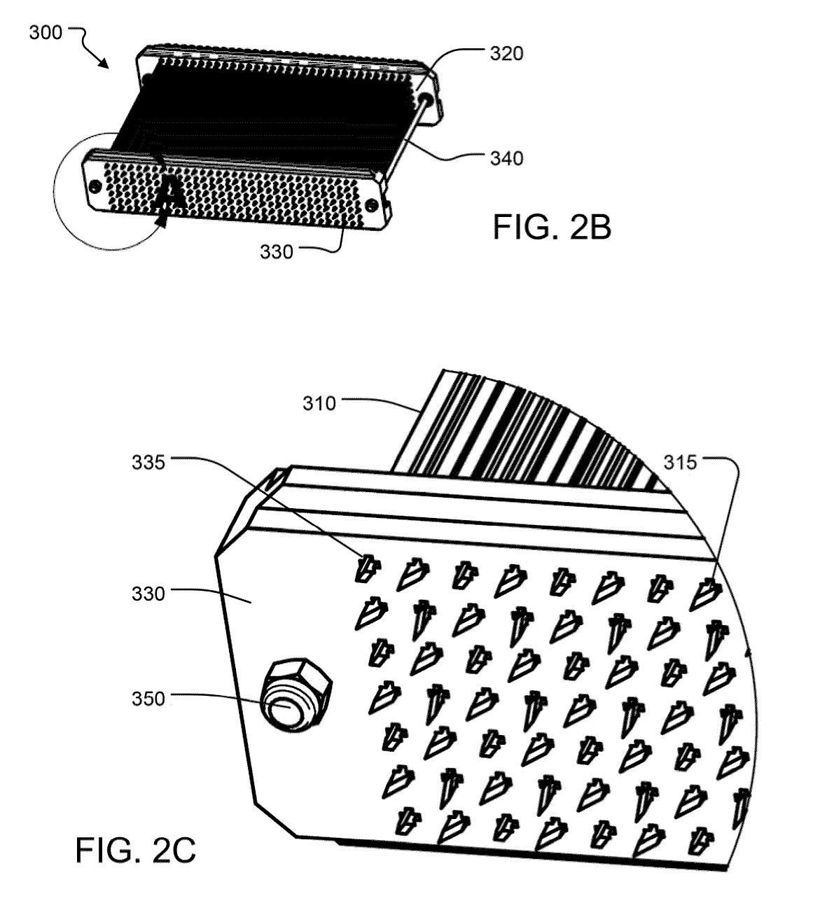

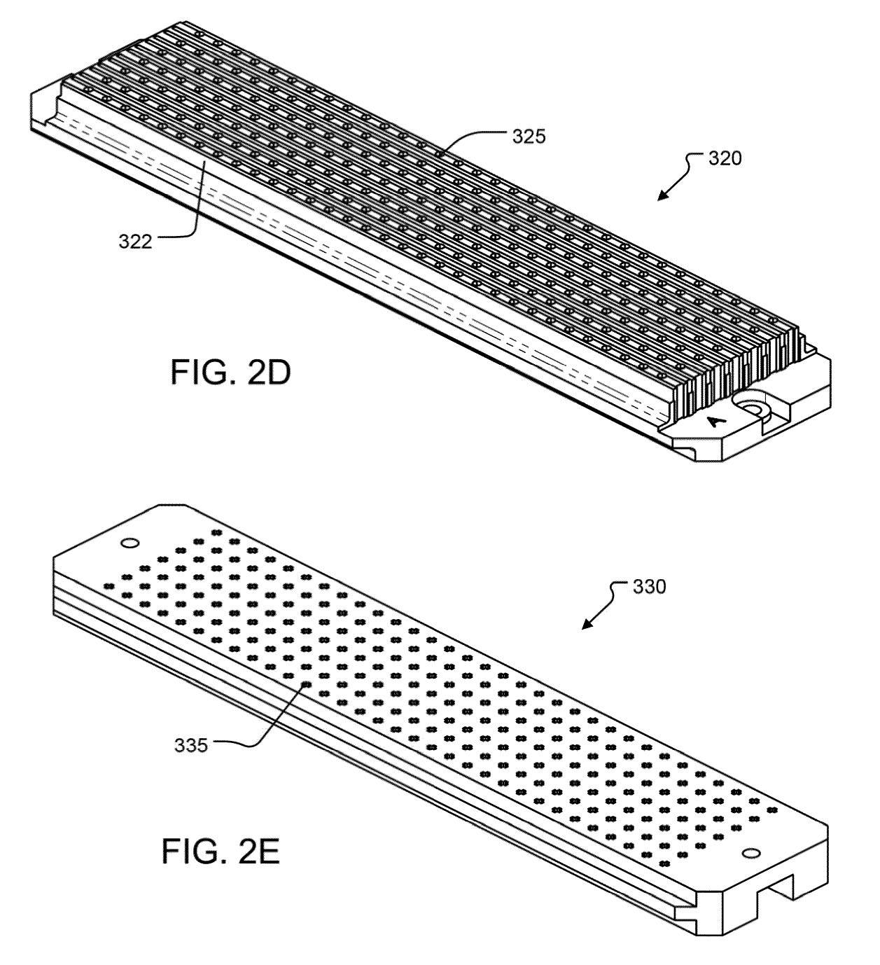

FIG. 2A shows an example of a food conditioning head 300 that may be used in the food processer 30 to process food products, according to the principles of the disclosure. The head 300 may include a plurality of blades 310, a blade carrier 320, a guide plate 330, and a plurality of guide rods 340. Each guide rod 340 may include, for example, a threading (not shown) on both ends and a flange 345 located near the threading at one end. The flange 345 end of each guide rod 340 may be fixedly secured to the guide plate 330 by a fastener 350. The other, opposite end of each guide rod 340 may be capped by the fastener 350, which may serve as a stop for limiting the movement of the blade carrier 320 along the guide rods 340. The fastener 350 may include, for example, a nut, a bolt, a screw, a weld, a rivet, or the like. The blade carrier 320 may include a guide 355 on each of its longitudinal ends for receiving a respective guide rod 340. The guide 355 may include a bushing, a bearing, or the like, that is configured to provide substantially frictionless linear movement of the guide rod 340 there-thru. The guide rods 340 together with the guides 355 provide free moving alignment of the blade carrier 320 and the guide plate 330 to guide the blades 310 cleanly and smoothly into the food product.

The functionality, durability and strength of the food processor 30 is enhanced by the upward and downward movement of the plurality of blades 310 and the head 300 configuration. In this regard, the blade carrier 320 and/or the guide plate 330 may be made from high strength plastic and/or steel.

Although the example of the head 300 shown in FIG. 2A includes a pair of guide rods 340, it is noted that the head 300 may include any number of guide rods 340, such as, for example, three, four, five, six, and the like, but preferably even numbers of guide rods 340, such as, for example, four, six, eight, and the like. The blade carrier 320 and/or the guide plate 330 may be made from materials such as, for example, a plastic, a metal, or the like, or a combination of the foregoing. The plastic may include a high strength plastic, such as, for example, Ertalyte®, or the like. The metal may include, for example, stainless steel, or the like. The blade carrier 320 and/or the guide plate 330 may be made entirely from stainless steel to minimize the risk of breakage. The blade carrier 320 may include slotted plastic inserts (not shown) for less friction due to the relative motion between the blade carrier 320 and the blades 310.

The blade carrier 320 may include, for example, an upper an upper plate and a lower blade alignment bushing plate (not shown), which may be coupled together by a fastener (not shown), such as, for example, a tongue-and-groove coupling, a screw, a bolt, a nut, a rivet, an adhesive, or the like.

FIG. 2B shows a perspective, bottom view of the head 300, according to the principles of the disclosure.

FIG. 2C shows a detailed view of an area A noted in FIG. 2B. As seen in FIG. 2C, the guide plate 330 includes a plurality of thru-openings 335 for receiving and guiding a respective plurality of the blades 310 there-thru. Each of the plurality of openings 335 may include, for example, a cross pattern. Each blade 310 may have a profile width along two of its sides that is about, for example, three times the width along the other two sides of the blade 310. The blades 310 may be configured to penetrate directly into the interior of the food product (not shown). For maximum tenderization and cutting of, for example, connective tissue, the blades 310 may be configured in a crisscross pattern, with every other blade 310 being turned about 90° to ensure that sinew is sliced and the processed food product is made more tender.

It is noted that other configurations for the blades 310 may be equally used, including width ratios that are substantially greater (or smaller) than about 3:1. It is also noted that the head 300 is not limited to a single guide plate 330, but may include two or more guide plates 330 for added rigidity of the blades 310 during operation of the food conditioner 10 (shown in FIG. 1).

FIG. 2D shows a perspective view of an example of the blade carrier 320. The blade carrier 320 may include a plurality of receptacles 325 for receiving and securely holding a respective plurality of blades 310. The receptacles 325 may be formed in a plurality of longitudinal magnets 322, or the receptacles 325 maybe formed in a plurality of longitudinal plates sandwiched between the longitudinal magnets 322. Thus, the blades 310 may be easily affixed and secured to the blade carrier 320, allowing for easy replacement of any one or more of the plurality of blades 310.

It is noted that if the food products include only bone-less products, then the plurality of blades 310 may be fixed to the blade carrier 320, instead of being held in place by the longitudinal magnets 322.

FIG. 2E shows a perspective view of an example of the guide plate 330, constructed according to the principles of the disclosure. As seen in the figure, the guide plate 330 may include a plurality of cross pattern thru-openings 335 for receiving and guiding a respective plurality of blades 310.

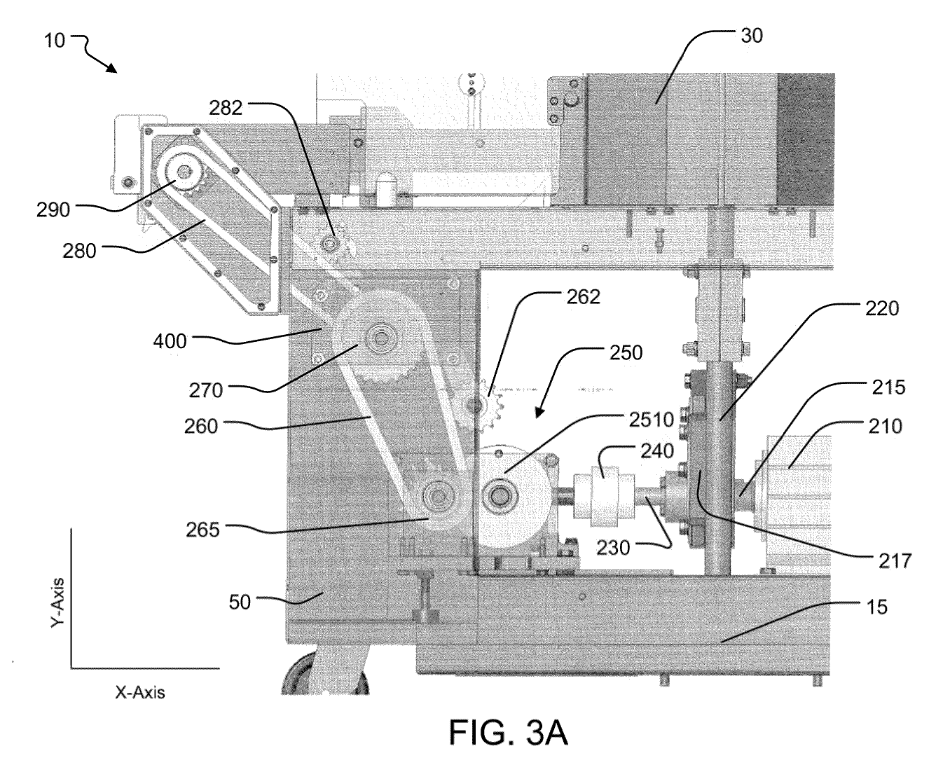

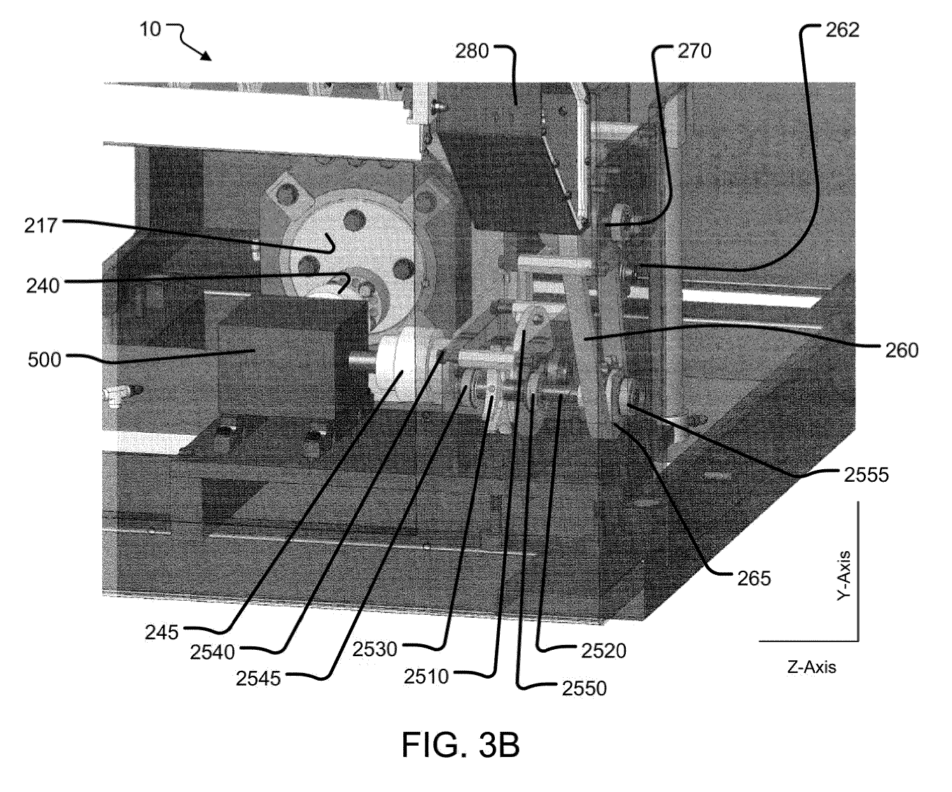

FIG. 3A shows a detailed, partial x-y plane view of a portion of the food conditioner 10. The food conditioner 10 may include a motor 210 for driving the input transport 20, the food processor 30, and/or the output transport 40. The food processor 30 may include a plurality of food conditioning heads 300 (shown in FIG. 2A), which may be configured to penetrate the food product (not shown) either (or both) vertically (e.g., along y-axis, shown in FIG. 3A) or horizontally (e.g., along z-axis, shown in FIG. 3B). The motor 210 may be affixed to a chassis 15 of the food conditioner 10. The motor 210 may include a rotor shaft 215 that may be coupled to a cam unit 217, which may be coupled to a drive unit 220. The motor 210 may include, for example, a regulated stepper or servo motor. The cam unit 217 may include a cam (not shown) that is coupled to the shaft 215. The cam may be configured to engage and drive one or more lifters (not shown) that may be provided in the drive unit 220, lifting and lowering the one or more lifters as the cam rotates with the rotation of the shaft 215. The lifters may be coupled to one more food conditioning heads 300, driving the blades 310 into a food conditioning chamber (not shown) in the food processor 30 and retracting the blades 310 from the food conditioning chamber. The cam unit 217 may be coupled to a drive system 250 through a drive shaft 230 and a motor coupler 240.

The drive system 250 may include a master drive gear 2510 and a force limiting slip clutch assembly (or slip clutch) 265. The master drive gear 2510 may include, for example, a Geneva drive gear. The drive system 250 may be coupled to the input transporter 20 by means of a belt 260, a sprocket (or pulley) 270, a belt 280, and a sprocket (or pulley) 290. A plurality of tensioners 262, 282 may be provided to apply a respective force to the belts, 260, 280 to keep the belts taut. The tensioners 262, 282 may include, for example, sprockets, pulleys, wheels, or the like. The sprocket 270 and the plurality of tensioners 262, 282 may be assembled in a sprocket (or pulley) assembly 400. The belts 260, 280 may include, for example, a stainless steel belt, a serpentine belt, a Gilmer belt, a chain, a timing belt, a V-belt, or the like.

FIG. 3B shows a detailed, partial z-y plane view of a portion of the food conditioner 10. The drive system 250 may further include a slave drive gear shaft 2520, a slave drive gear 2530, a mount assembly 2540, a plurality of guides 2545, 2550, 2555, a motor coupler 245, and a gear assembly 500. The drive (or driven) shaft 2520 is configured to be driven by a force that is transferred from the master drive gear 2510 via the slave drive gear 2530. The slave drive gear 2530 includes a gear that is configured to engage and be driven by the master drive gear 2510, which may include a Geneva drive gear. The master drive gear 2510 and the slave drive gear 2530 together makeup a continuous-to-intermittent converter 2510, 2530 that converts a continuous rotary motion of the master drive gear 2510 to an intermittent rotary motion of the slave drive gear 2530, with the drive gear 2530 turning during discrete intervals of time. The guides 2545, 2550, 2555, which may include a bearing (such as, for example, a ball bearing), are configured to support and allow the slave drive gear shaft 2520 to rotate without any friction, or with substantially zero friction.

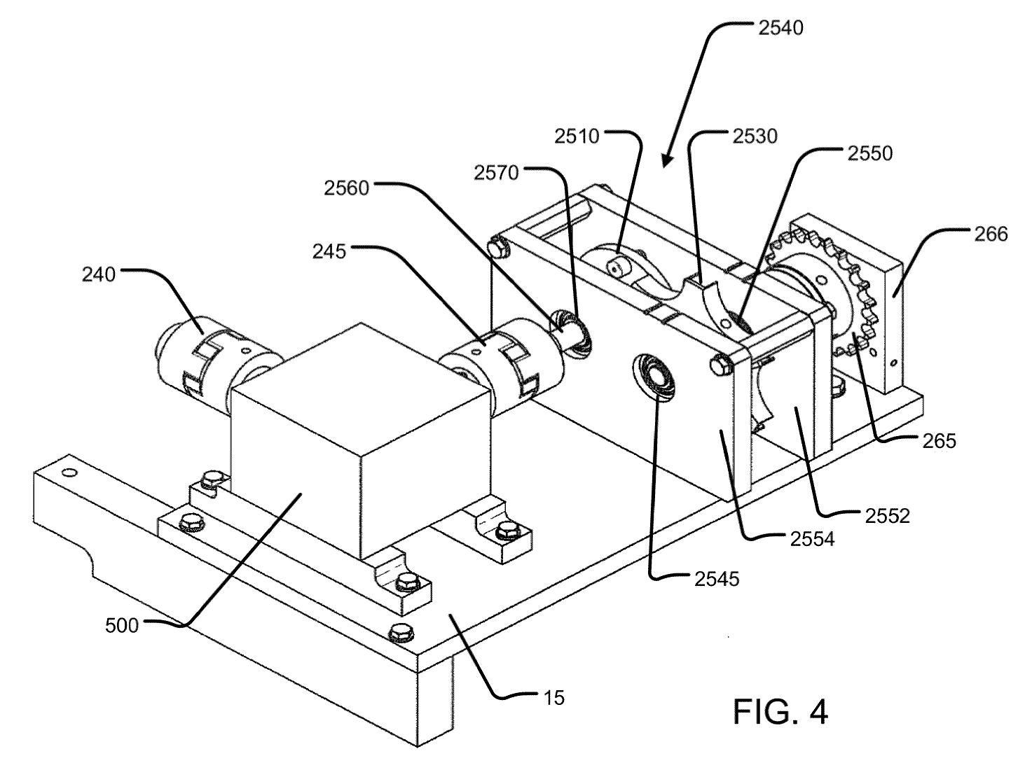

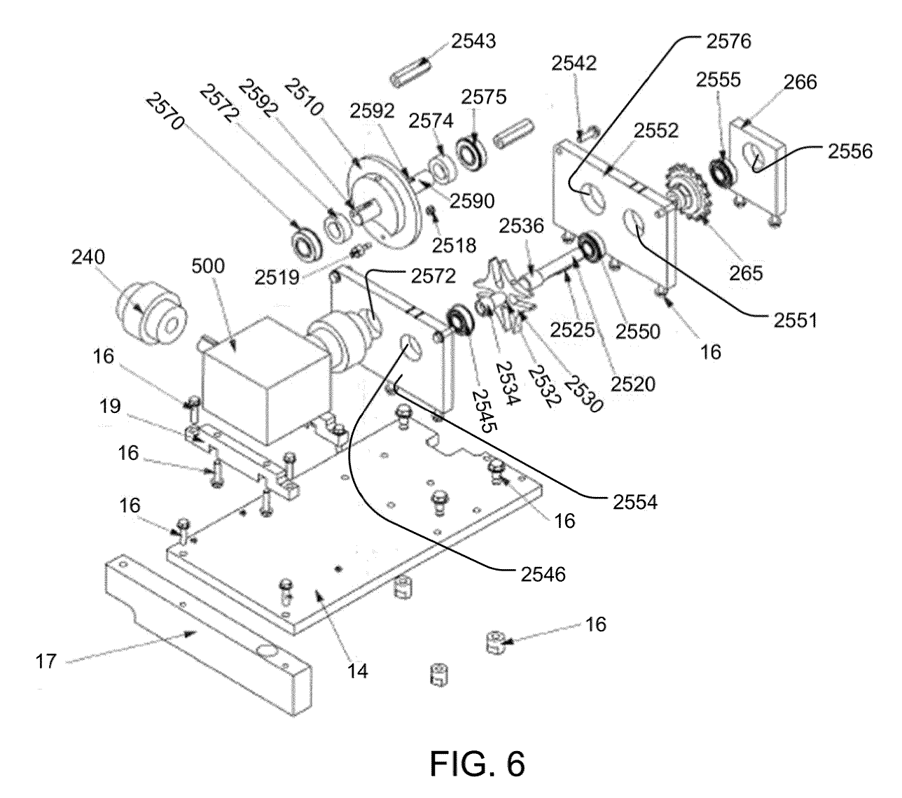

FIG. 4 shows a perspective view of the drive system 250. The drive system 250 may include, for example, a plurality of support members 266, 2552, 2554, a shaft 2560, and a plurality of guides 2570, 2575 (shown in FIG. 6). The guide 2570 may be configured substantially the same as (or different) to the guides 2545, 2550, 2555. The plurality of support members 266, 2552, 2554 may be affixed to the chassis 15. The plurality of support members 266, 2552, 2554 may include the plurality of guides 2570, 2555, 2550, 2545. Each of the support members 266, 2552, 2554 may be configured in the shape of a plate that may be affixed to the chassis 15.

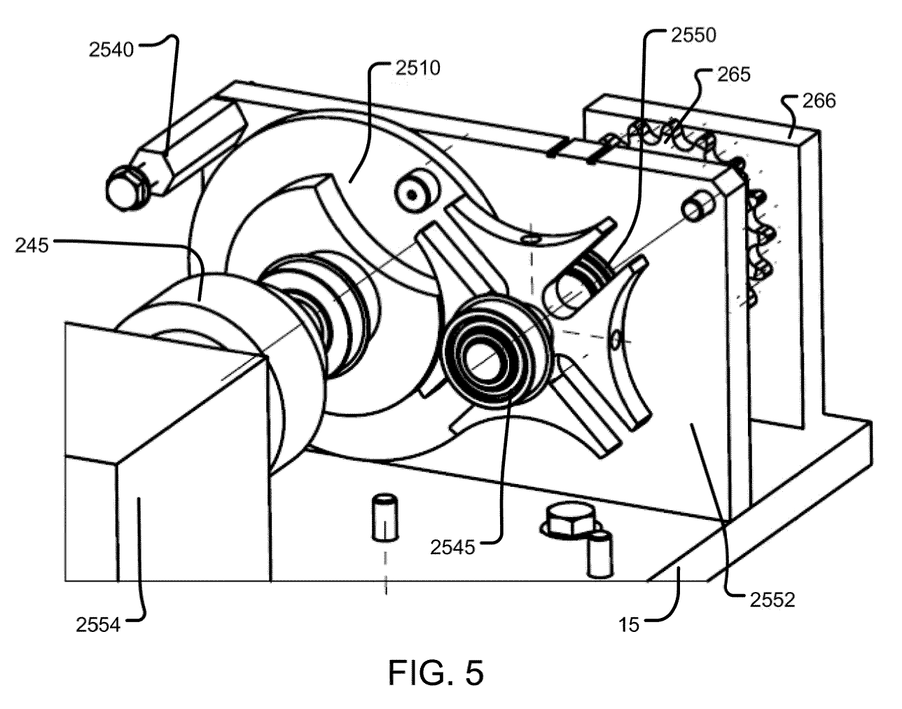

FIG. 5 shows a detailed view of a portion of the drive system 250, constructed according to the principles of the disclosure.

FIG. 6 shows an exploded view of the drive system 250. As seen, the support member 266 may include an opening 2556 that is configured to receive and securely hold the guide 2555 in place. The guide 2555 is configured to receive one end of the shaft 2520 and to allow the shaft 2520 to rotate without any friction, or with substantially zero friction.

The support member 2552 may include a pair of openings 2551, 2576 for receiving and securely holding the guides 2550, 2575, respectively. The guide 2550 is configured to receive and support the shaft 2520, allowing the shaft 2520 to rotate with substantially zero friction. The slip clutch assembly 265 may be mounted to the shaft 2520 and positioned between the support member 266 and the support member 2552. The guide 2575 is configured to receive and support one end of a shaft 2590, allowing the shaft 2590 to rotate with substantially zero friction.

The support member 2552 may be affixed to the chassis 15 by means of a plurality of fasteners 16. Each fastener 16 may include, for example, a bolt, a nut, a screw, a weld, a pin, a rivet, or the like, or a combination of the foregoing.

The support member 2554 may include a pair of openings 2546, 2572 for receiving and securely holding the guides 2545, 2570, respectively. The guide 2545 may be configured to receive and support another end of the shaft 2520, which is opposite to the end of the shaft 2520 that may be supported by the guide 2555. The guide 2570 may be configured to receive and support a portion of the shaft 2590, allowing the end of the shaft 2590 to pass through the guide 2570 and engage the motor coupler 245, where the end of the shaft 2590 may be coupled to the motor coupler 245. The guides 2545, 2570 are configured to allow the shafts 2520, 2590, respectively, to rotate without any friction, or with substantially zero friction.

The support member 2552 may be coupled to the support member 2554 through the mount assembly 2540. The mount assembly 2540 may include a plurality of fasteners 2542, 2543. The fasteners 2542, 2543 may include, for example, a screw and a spacer, respectively. The fastener 2542 may be configured to be substantially the same as, for example, the fasteners 16.

In between the support members 2552 and 2554, a pair of spacers 2572, 2574 may be provided on the shaft 2590 on either side of the master drive gear 2510. The spacers 2572, 2574 may include, for example, bushings, or the like. The shaft 2590 may include a recess (or key) 2592 for engaging a portion of the master drive gear 2510 and preventing the master drive gear 2510 from rotating with respect to the shaft 2590. The master drive gear 2510 may include a cam follower 2519, which may be affixed to the master drive gear 2510 by a fastener 2518. The fastener 2518 may be similar to the fastener 16.

Also in between the support members 2552 and 2554, a pair of spacers 2534, 2536 may be provided on the shaft 2520 on either side of the slave drive gear 2530. The spacers 2534, 2536 may include, for example, bushings, or the like. The shaft 2520 may include one or more recesses (or keys) 2532, 2525 for engaging a portion of the slave drive gear 2530 and a portion of the slip clutch assembly 265, respectively, to prevent the slave drive gear 2530 or the portion of the slip clutch assembly 265 from rotating with respect the shaft 2520.

As seen in FIG. 6, the various components of the drive system 250 may be coupled to the chassis 15 by means of a plurality of the fasteners 16. The chassis 15 may include a base plate 14 and a frame 17. For example, the gear assembly 500 may be affixed to the base plate 14 by means of the fasteners 16. A pair of support blocks 19 may be placed between the gear assembly 500 and the base plate 14.

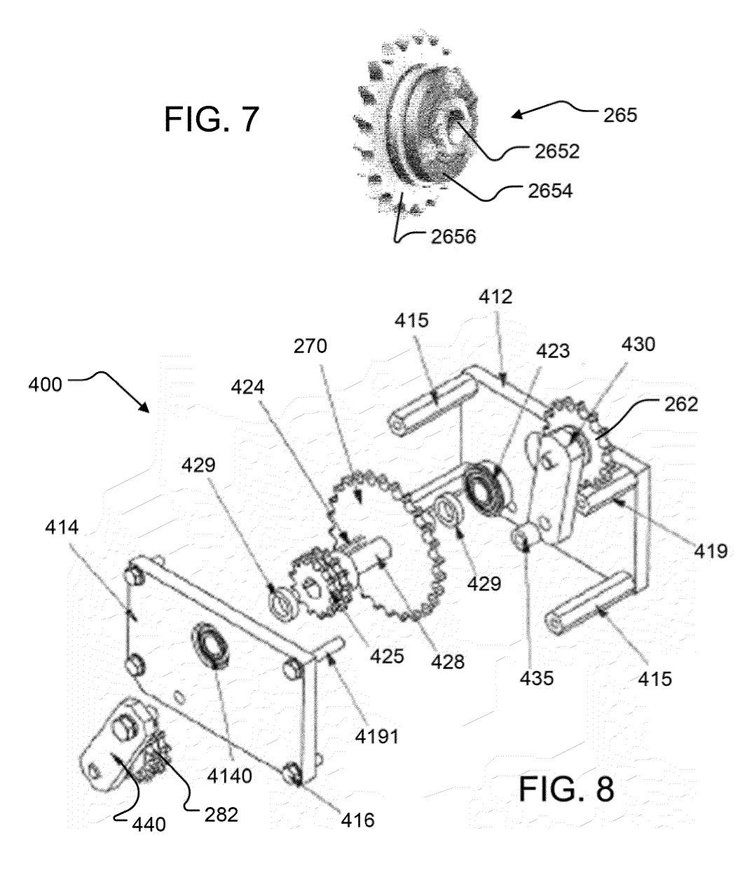

FIG. 7 shows an example of a slip clutch assembly 265, according to the principles of the disclosure. The slip clutch assembly 265 includes an opening 2652 for receiving and passing there-thru the end portion of the shaft 2520. The slip clutch assembly 265 further includes a clutch portion 2654 and an engager portion 2656. The engager portion 2656 may include a sprocket, a pulley, or the like, or a combination of the foregoing. The clutch portion 2654 is configured to engage or disengage the engager portion 2656 to cause the engager portion 2656 to rotate. The clutch portion 2654 may include a spring (not shown), a bushing (not shown), or the like. The slip clutch assembly 265 is configured to limit the transfer of torque from the drive shaft 2520 to the belt 260, disengaging the engager portion 2656 from the shaft 2520 when the torque on the engager portion 2656 exceeds a predetermined threshold, such as, for example, about 18.7 ft-lbs, but other threshold values may be used, as will be appreciated by one having ordinary skill in the art. For example, the threshold value may be dependent on the materials selected for the various components and the corresponding coefficients of static friction, conveyor belt lengths, the particular food products to be processed, and the like. The particular configuration of the engager portion 2656 should be matched to the configuration of the belt 260 (shown in FIG. 3A), which is to be driven by the engager portion 2656.

FIG. 8 shows an example of the sprocket (or pulley) assembly 400, which is constructed according to the principles of the disclosure. The sprocket assembly 400 includes the sprocket 270 and the plurality of tensioners 262, 282. The sprocket assembly 400 may include a pair of assembly supports 412, 414 that may be rigidly spaced apart by a plurality of spacers 415, which may have substantially the same (or different) lengths, and secured to each other by a plurality of fasteners 416. The fasteners 416 may be substantially the same as, or similar to the fasteners 16.

The assembly supports 412, 414 may include, for example, a pair of plates. In between the assembly supports 412, 414, the sprocket 270, a sprocket (or pulley) 425 and a plurality of spacers 429 may be mounted to a shaft 428. The spacers 429 may include, for example, bushings. One end of the shaft 428 may be inserted in and supported by a guide 423. The other, opposite end of the shaft 428 may be inserted in and supported by a guide 4140. The guides 423, 4140 may be located in the assembly supports 412, 414, respectively. The guides 423, 4140 may include, for example, a ball bearing, or the like, to rotationally support the shaft 428, allowing the shaft 428 to rotate with substantially zero friction. The shaft 428 may include a recess (or key) 424 that is configured to engage a corresponding protrusion (not shown) on the sprockets 270, 425, so as to secure the sprockets 270, 425 to the shaft 428 and prevent the sprockets 270, 425 from rotating with respect to the shaft 428. The sprocket 425 may be configured to engage and drive the belt 280 (shown in FIG. 3A), while the sprocket 270 engages and receives a driving force from the belt 260 (also shown in FIG. 3A).

The tensioners 262, 282 may be coupled to a pair of idlers 430, 440, respectively. The idler 430 may be coupled between the assembly supports 412, 414 by means of spacers 419, 435 and a fastener 4191. The spacer 435 may include, for example, a bushing, and the spacer 419 may include, for example, a threaded stand-off fastener. The idler 440 may be coupled to the assembly support 414. Each of the idlers 430, 440 may further include a spring (not shown) to rotationally bias the position of the idlers 430, 440 with respect to the sprocket assembly 400, so as to provide tension, for example, to the belts 260, 280 (shown in FIG. 3A), respectively.

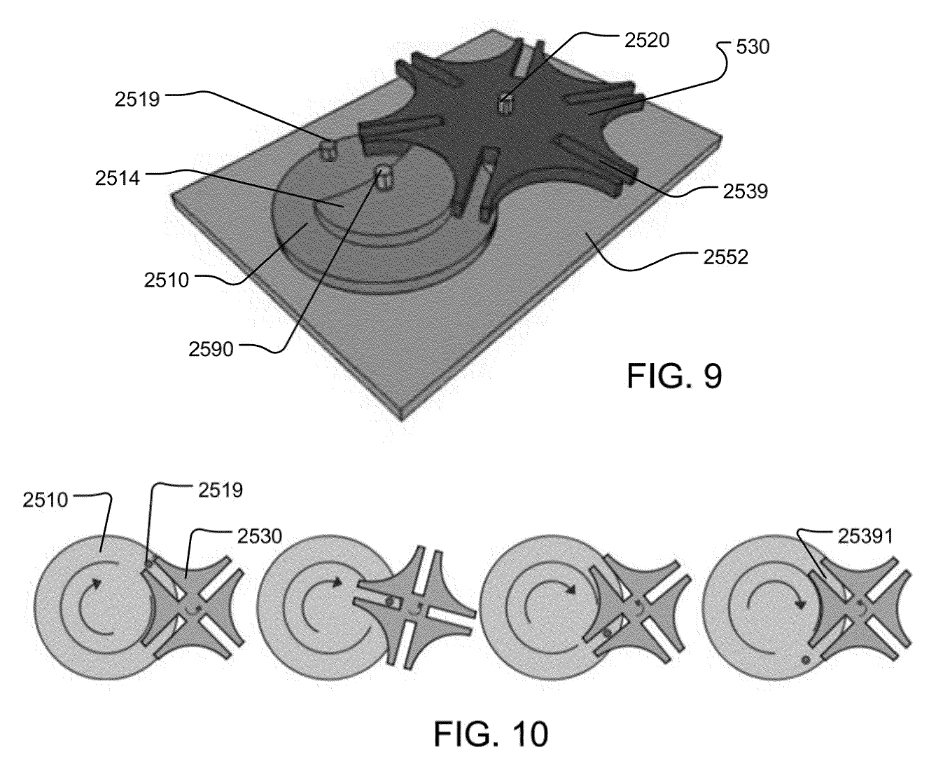

FIG. 9 shows a representation of an example of the master drive gear 2510 and a complementary slave drive gear 530, according to principles of the disclosure. The master drive gear 2510 includes the cam follower 2519 and a semi-cylindrical portion 2514. The slave drive gear 530 includes a plurality of slots 2539, each of which is configured to receive and engage the cam follower 2519. As seen in FIG. 9, the master drive gear 2510 may include a Geneva drive gear and the slave drive gear 530 (or 2530) may include a Maltese Cross drive gear. The slave drive gear 530 may include any number of slots 2539, including, for example, a single slot, two slots, three slots, four slots (as shown in FIG. 5), five slots, six slots (as shown in FIG. 9), or more. The master drive gear 2510 and the slave drive gear 530 (or 2530) are configured to convert a continuous rotation of the master drive gear 2510 to an intermittent rotary motion of the slave drive gear 530 (or 2530).

FIG. 10 shows four discrete examples of the rotational motion of the master drive gear 2510 and the slave drive gear 2530, according to principles of the disclosure. The four discrete examples show how the continuous rotational motion of the master drive gear 2510 may be harnessed and used to intermittently drive the slave drive gear 2530.

Referring to FIG. 10 from left to right, initially the cam follower 2519 reaches the opening of the slot 2539 of the slave drive gear 2530. The cam follower 2519 proceeds to travel along the length of the slot 2539 as the master driver gear 2510 rotates in, for example, a continuous clockwise direction. Simultaneously the cam follower 2519 engages and presses on a wall of the slot 2539, thereby causing the slave drive gear 2530 to rotate, for example, in a counter-clockwise direction. The master drive gear 2510 continues to rotate at a substantially constant speed, carrying the cam follower 2519 and driving the slave drive gear 2530 until the master drive gear 2510 and slave drive gear 2530 reach the configuration shown in the rightmost discrete example shown in FIG. 10, at which point the cam follower 2519 travels out of the slot 2539 while the slave drive gear 2530 remains stationary until the cam follower 2519 engages the slot 25391.

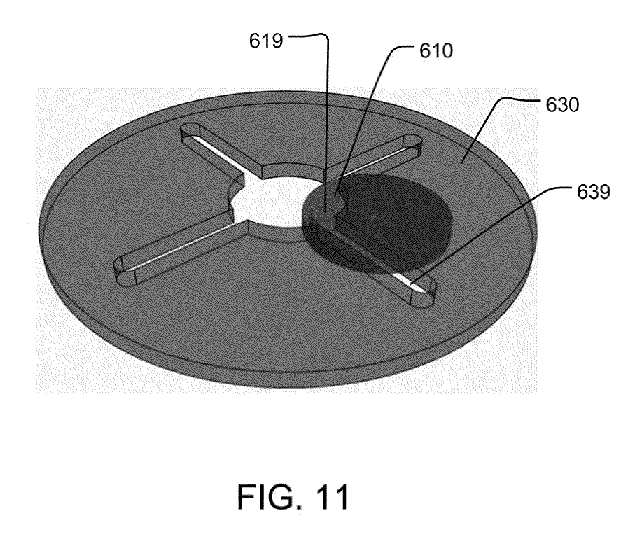

FIG. 11 shows another example of a master drive gear 610 that may be used in conjunction with another example of a slave drive gear 630, constructed according to principles of the disclosure. As seen in FIG. 11, the master drive gear 610 may include a cam follower 619 that is configured to travel into and engage the walls of one of a plurality of slots 639 provided in (or on) the slave drive gear 630.

It is noted that the master drive gear 610 and the slave drive gear 630 may be replaced with a servo motor (not shown) and a sensor (not shown) to trigger an independent servo motor motion in time with the lifting cam. A servo driver (not shown) may be included to regulate the motion, speed, acceleration and deceleration of rotation of the servo motor. The sensor may be configured to detect, for example, a timing element that may be affixed to the rotating cam.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

What is claimed:

1. A driver for a food conditioner, the driver comprising:
a drive shaft that is configured to be driven by a motor;
a continuous-to-intermittent converter that is configured to be coupled to the drive shaft; and
a slip clutch that is configured to be coupled to the continuous-to-intermittent converter,
wherein the slip clutch is further configured to disengage when a torque applied to the slip clutch exceeds a predetermined threshold.

2. The driver according to claim 1, wherein the continuous-to-intermittent converter comprises a Geneva drive gear.

3. The driver according to claim 1, wherein the continuous-to-intermittent converter comprises a Maltese Cross drive gear.

4. The driver according to claim 1, further comprising:
a driven shaft coupled to the continuous-to-intermittent converter and the slip clutch, the driven shaft being configured to drive the slip clutch.

5. The driver according to claim 1, wherein the slip clutch comprises:
an engager portion that is configured to drive a transporter; and
a clutch portion that is configured to disengage the engager portion to cause the engager portion to stop rotation while the drive shaft continues to rotate substantially continuously.

6. The driver according to claim 5, wherein the engager portion comprises a sprocket.

7. The driver according to claim 1, wherein the continuous-to-intermittent converter comprises:
a master drive gear coupled to the drive shaft; and
a slave drive gear that is intermittently coupled to the master drive gear.

8. The driver according to claim 7, wherein the master drive gear includes a cam follower and wherein the slave drive gear includes a slot that is configured to receive the cam follower.

9. The driver according to claim 1, further comprising a drive unit that is configured to drive a blade tenderizer that comprises:
a vertical blade tenderizer head made from stainless-steel, plastic or a stainless-steel and plastic composite,
wherein the vertical blade tenderizer head includes a free vertical travel lower blade alignment bushing.

10. The driver according to claim 9, wherein the drive unit comprises a lifter, the driver further comprising:
a cam unit that is coupled to the drive shaft.

11. The driver according to claim 9, wherein the tenderizer head provides cruciform criss-cross blade alignment, the tenderizer head comprising:
an upper blade retainer plate that holds a plurality of blades; and
a lower freely moving guide plate that guides the plurality of blades during tenderizing.

12. A driver for a food conditioner, the driver comprising:
a drive shaft that is configured to be driven by a motor;
a master drive gear that is coupled to the drive shaft;
a driven shaft that is configured to be driven by a force that is transferred from the master drive gear; and
a slip clutch that is coupled to the driven shaft.

13. The driver according to claim 12 wherein the master drive gear includes a cam follower.

14. The driver according to claim 12, further comprising:
a slave drive gear that is coupled to the driven shaft.

15. The driver according to claim 14, wherein the slave drive gear is configured to intermittently engage the master drive gear while the master drive gear continues to rotate substantially continuously.

16. The driver according to claim 14, wherein the master drive gear comprises a Geneva drive gear.

17. The driver according to claim 14, wherein the slave drive gear comprises a Maltese Cross drive gear.

18. The driver according to claim 14, wherein the slave drive gear comprises a slot that is configured to receive a portion of the master drive gear.

19. The driver according to claim 12, wherein the slip clutch is configured to disengage when a torque applied to the slip clutch exceeds a predetermined threshold.

20. The driver according to claim 12, wherein the slip clutch comprises:
an engager portion that is configured to drive a transporter; and
a clutch portion that is configured to disengage the engager portion to cause the engager portion to stop rotation while the drive shaft continues to rotate substantially continuously.

21. A driver for a food conditioner, the driver comprising:
a drive shaft that is configured to be driven by a motor;
a Geneva drive gear coupled to the drive shaft, the Geneva drive gear comprising a cam follower;
a driven shaft that is configured to drive a transport;
a Maltese Cross drive gear coupled to the driven shaft, the Maltese Cross drive gear comprising a slot for receiving and engaging the cam follower; and
a slip clutch coupled to the driven shaft,
wherein the slip clutch is configured to disengage when a force applied to the slip clutch exceeds a predetermined threshold.
